(19) United States
(12) Patent Application Publication
(10) Pub. No.: US 2004/0206100 A1
(43) Pub. Date: Oct. 21, 2004

(54) Air conditioner for vehicle capable controlling air flow into plural zones

(76) Inventors: Takahiro Tokunaga, Kosai-city (JP); Koji Ito, Nagoya-city (JP); Yoshihiko Okumura, Kariya-city (JP)

Correspondence Address: HARNESS, DICKEY & PIERCE, P.L.C., P.O. BOX 828, BLOOMFIELD HILLS, MI, 48303, US

(21) Appl. No.: 10/805,989

(22) Filed: Mar. 22, 2004

(30) Foreign Application Priority Data
Mar. 24, 2003 (JP) 2003-079975
Jan. 30, 2004 (JP) 2004-022969

(51) Int. Cl. B60H 1/32; F25D 25/02; B60H 1/00; F25D 17/00

(52) U.S. Cl. 62/179; 62/244; 62/180; 165/203; 165/204

(57) ABSTRACT

The temperature of air discharged from first and second passages are adjusted by adjusting the proportion of a flow rate of cold air with respect to that of hot air by means of a first cold air door 26 and a first hot air door 24, and by means of a second cold air door 27 and a second hot air door 25. Discharged air flow rates are controlled by changing the areas of the first and second passages while the proportion of the flow rate of cold air with respect to that of hot air is maintained to be constant by means of the first cold air door 26 and the first hot air door 24, and by means of the second cold air door 27 and the second hot air door 25.

### BACKGROUND OF THE INVENTION

1. Field of the Invention

The present invention relates to control of the quantity of air flow rate in an air conditioner for a vehicle. More specifically, the present invention is preferably applicable to an air conditioner for a vehicle in which the flow rates of air discharged into a left side zone and of air discharged into a right side zone, in a vehicle compartment, are controlled independently of each other.

2. Description of the Related Art

A prior art for controlling the flow rates of air discharged (blowing) into the left side and into the right side zones in a vehicle compartment, for an air conditioner for a vehicle, has been proposed in Patent document 1.

In this prior art, the inside of a duct connecting a discharge outlet of a single fan unit to an inlet of a cooling heat exchanger (evaporator) is partitioned into a vehicle left side passage and a vehicle right side passage and, at the same time, an airflow distributing door made of a single board door is rotatably arranged at a partitioning part of the passages, and the flow rates of air discharged to the left side and right side zones in a vehicle compartment are changed by changing the opening ratio of the left side passage with respect to the right side passage within the duct using the single air flow distributing door.

[Patent Document 1]

Japanese Patent No. 2682627

According to the above-mentioned prior art, however, if the opening area of one of the left side and right side passages within the duct is decreased, the opening area of the other passage inevitably increases as a result and, therefore, it is difficult to change the air flow rate of only one of the passages. Moreover, as a dedicated air distributing door for controlling the air flow rate to the left side and right side passages is arranged, an additional space for installing the air flow distributing door is required and, therefore, the air conditioner becomes more bulky and the installation of the air conditioner, on a vehicle, becomes more difficult.

The above-mentioned prior art describes a case where the flow rates of air discharged to the left side and the right side zones in a vehicle compartment are controlled, but the same problem arises in a case where the flow rates of air discharged to front and back zones in a vehicle compartment are controlled.

### SUMMARY OF THE INVENTION

The above-mentioned problems being taken into account, the object of the present invention is to provide an independent air flow rate control mechanism capable of changing the air flow rate in one of two or more air passages while keeping the change in air flow rate small in the other air passage or passages in an air conditioner for a vehicle having two or more air passages through which conditioned air is independently discharged into two or more zones in a vehicle compartment.

The other object of the present invention is to provide an air conditioner for a vehicle capable of independently controlling the air flow rates in two or more air passages by using door means for adjusting the discharged (blowing) air temperature in a vehicle compartment without any additional means.

In order to attain the above-mentioned objects, in a first aspect of the present invention:

a first cold air passage (20) through which cold air flows and a first hot air passage (22) through which hot air flows are provided, in parallel with each other, in a first air passage (18) through which conditioned air is discharged to a first zone in a vehicle compartment, and a second cold air passage (21) through which cold air flows and a second hot air passage (23) through which hot air flows are provided, in parallel with each other, in a second air passage (19) through which conditioned air is discharged to a second zone in a vehicle compartment;

the first air passage (18) comprises a first cold air door (26) for opening and closing the first cold air passage (20) and a first hot air door (24) for opening and closing the first hot air passage (22), and the second air passage (19) comprises a second cold air door (27) for opening and closing the second cold air passage (21) and a second hot air door (25) for opening and closing the second hot air passage (23);

the temperature of air discharged from the first air passage (18) into the first zone is adjusted by adjusting the proportion of the flow rate of cold air in the first cold air passage (20) with respect to the flow rate of hot air in the first hot air passage (22) by means of the first cold air door (26) and the first hot air door (24), and the temperature of air discharged from the second air passage (19) into the second zone is adjusted by adjusting the proportion of the flow rate of cold air in the second cold air passage (21) with respect to the flow rate of hot air in the second hot air passage (23) by means of the second cold air door (27) and the second hot air door (25); and

the air flow rate in the first air passage (18) is controlled independently by changing the passage opening area of the first air passage (18) by means of the first cold air door (26) and the first hot air door (24) while the proportion of the flow rate of cold air with respect to the flow rate of hot air adjusted by means of the first cold air door (26) and the first hot air door (24) is maintained to be constant, and the discharged (blowing) air flow rate in the second air passage (19) is controlled independently by changing the passage opening area of the second air passage (19) by means of the second cold air door (27) and the second hot air door (25) while the proportion of the flow rate of cold air with respect to the flow rate of hot air adjusted by means of the second cold air door (27) and the second hot air door (25), is maintained to be constant.

According to the first aspect, it is not only possible to adjust the temperature of the air discharged to the first zone by adjusting the proportion of the flow rate of cold air with respect to that of hot air in the first air passage (18) by means of the first cold air door (26) and the first hot air door (24) but also to independently control the air flow rate in the first air passage (18) by changing the passage opening area of the first air passage (18) while maintaining the proportion of the flow rate of cold air with respect to that of hot air to be constant.

As a result, it is possible to independently control the air flow rate in the first air passage (18) by using the first cold air door (26) and the first hot air door (24) serving as an adjusting means for the discharged (blowing) air temperature in the first air passage (18).

Similarly, in the second air passage (19), it is possible to independently control the air flow rate in the second air passage (19) by using the second cold air door (27) and the second hot air door (25) serving as an adjusting means for the discharged air temperature in the second air passage (19).

Because of this, it is not necessary to additionally arrange a door means for independently controlling the air flow rate in each passage, resulting in a considerable advantage that the air conditioner for a vehicle can be made more compact and the cost can be reduced.

Moreover, it is also possible to change the passage opening area of only the first air passage (18) by means of the first cold air door (26) and the first hot air door (24) or to change the passage opening area of only the second air passage (19) by means of the second cold air door (27) and the second hot air door (25). In other words, when the air flow rate of one of the passages is changed, it is possible to keep the change in air flow rate in the other passages small, compared to the prior art described in Patent document 1, because the opening area of only one of the first and second air passages (18, 19), the air flow rate of which is changed, is changed and the opening area of the other passage is not changed.

In a second aspect of the present invention, the air conditioner for a vehicle according to the first aspect comprises: a first temperature setting means (52a) operated by a passenger and for generating a temperature setting signal of the first zone in a car room, and a second temperature setting means (52b) operated by a passenger and for generating a temperature setting signal of the second zone in a car room;

a first air flow rate adjusting means (52f) operated by a passenger and for generating a discharged (blowing) air flow rate adjusting signal of the first air passage (18);

a second air flow rate adjusting means (52g) operated by a passenger and for generating a discharged (blowing) air flow rate adjusting signal of the second air passage (19);

a first door operation mechanism (28, 30) for operating the first cold air door (26) and the first hot air door (24);

a second door operation mechanism (29, 31) for operating the second cold air door (27) and the second hot air door (25); and

a control means (50) for receiving signals from the first temperature setting means (52a), the second temperature setting means (52b), the first air flow rate adjusting means (52f) and the second air flow rate adjusting means (52g) to control the first door operation mechanism (28, 30) and the second door operation mechanism (29, 31); wherein

the first door operation mechanism (28, 30) is controlled by the control means (50) when a discharged air flow rate adjusting signal of the first air passage (18) is generated by the first air flow rate adjusting means (52f), so that the first cold air door (26) and the first hot air door (24) are operated to be shifted to positions which provide passage opening areas in accordance with the increase or decrease of air flow rate specified by the discharged air flow rate adjusting signal; and wherein the second door operation mechanism (29, 31) is controlled by the control means (50) when a discharged air flow rate adjusting signal of the second air passage (19) is generated by the second air flow rate adjusting means (52g), so that the second cold air door (27) and the second hot air door (25) are operated to be shifted to positions which provide passage opening areas in accordance with the increase or decrease of air flow rate specified by the discharged air flow rate adjusting signal.

According to the second aspect, in addition to it being possible to independently and automatically control the discharged air temperature in the first and second air passages (18, 19) by independently controlling the operation mechanism (28, 30) of the doors (24, 26) of the first air passage (18) and the operation mechanism (29, 31) of the doors (25, 27) of the second air passage (19), it is also possible to increase or decrease the air flow rate from the first and second air passage (18, 19) in accordance with the preference of a passenger based on the discharged air flow rate adjusting signal generated by the manual operation of the first and second air flow rate adjusting means (52f, 52g).

In a third aspect of the present invention, the air conditioner for a vehicle in the second aspect comprises a single fan (10) for supplying air to the first air passage (18) and the second air passage (19); wherein

the control means (50) calculates a target blowing (discharged) air temperature (TAOL) of air discharged from the first air passage (18) into the first zone in a vehicle compartment and a target blowing (discharged) air temperature (TAOR) of air discharged from the second air passage (19) into the second zone in a vehicle compartment,

wherein the control means (50) determines a reference air flow rate of the air flow rate from the first air passage (18) and the second air passage (19) by controlling the air flow rate of the fan (10) based on at least one of the target blowing air temperatures (TAOL, TAOR),

wherein the control means (50) controls the first door operation mechanism (28, 30) so as to increase or decrease the reference air flow rate when a discharged air flow rate adjusting signal of the first air passage (18) is generated by the first air flow rate adjusting means (52f); and

wherein the control means (50) controls the second door operation mechanism (29, 31) so as to increase or decrease the reference air flow rate when a discharged air flow rate adjusting signal of the second air passage (19) is generated by the second air flow rate adjusting means (52g).

According to the third aspect, it is possible to increase or decrease the air flow rate from the first and second air passages (18, 19), in accordance with the preference of a passenger, by increasing or decreasing the reference air flow rate determined based on at least one of the target blowing air temperatures (TAOL, TAOR) based on the discharged air flow rate signal generated by the first and second air flow rate adjusting means (52f, 52g), when air is discharged from the single fan (10) to the first and second air passages (18, 19).

In a fourth aspect of the present invention, the air conditioner for a vehicle in the first or second aspect comprises a single fan (10) for supplying air to the first air passage (18) and the second air passage (19), wherein

when air flow rate in one of the first air passage (18) and the second air passage (19) is changed by means of the cold air door and the hot air door provided in the air passage, the air flow rate of the fan (10) is corrected so that a change in air flow rate in the other air passage can be kept small.

According to the fourth aspect, when air is supplied to the first and second air passages (18, 19) from the single fan (10) and when the air flow rate of one of the passages is changed by changing the opening area of the passage by means of the cold air door and the hot air door, it is possible to prevent, without fail, an air flow rate in the other passage from being changed by incorporating the correction of air flow rate of the fan (10).

In a fifth aspect of the present invention, each of the first cold air door (26), the first hot air door (24), the second cold air door (27) and the second hot air door (25) in the air conditioner for a vehicle in any one of the first to fourth aspects is made of a film door which comprises a film-like member and changes the passage opening area by moving each of the film-like members (24a to 27a).

By making each of the doors (24 to 27) of the film door as described above, the door operating space can be reduced and the air conditioner for a vehicle can be made more compact in an effective manner.

As in a sixth aspect of the present invention, each of the first cold air door (26), the first hot air door (24), the second cold air door (27) and the second hot air door (25) in the air conditioner for a vehicle in any one of the first to fourth aspects may be made of a board door rotatable about each axis of rotation (24d to 27d).

A seventh aspect of the present invention comprises: a first air passage (18) through which conditioned air is discharged to a first zone in a vehicle compartment; a second air passage (19) through which conditioned air is discharged to a second zone in a vehicle compartment; a single fan (10) for supplying air to the first air passage (18) and the second air passage (19); a first door means (24, 26) for independently controlling the air flow rate in the first air passage (18) by changing the passage opening area of the first air passage (18); and a second door means (25, 27) for independently controlling the air flow rate in the second air passage (19) by changing the passage opening area of the second air passage (19).

According to the seventh aspect, it is possible to independently control the air flow rate in the first air passage (18) by the means of the first door means (24, 26) and it is also possible to independently control the air flow rate in the second air passage (19) by means of the second door means (25, 27) when the single fan (10) supplies air to the first and second air passages (18, 19).

In an eighth aspect of the present invention, the first zone is a left side zone in a vehicle compartment, the first air passage is a vehicle left side air passage (18), the second zone is a right side zone in the vehicle compartment and the second air passage is a vehicle right side air passage (19) in the air conditioner for a vehicle in any one of the first to seventh aspects, wherein the air temperature and the flow rate of air discharged from the vehicle left side air passage (18) are independently controlled by means of the first cold air door (26) and the first hot air door (24), and

wherein the air temperature and the flow rate of air discharged from the vehicle right side air passage (19) are independently controlled by means of the second cold air door (27) and the second hot air door (25).

Because of this, it is possible to independently control the temperature and the flow rate of air discharged to the left side zone in a vehicle compartment and it is also possible to independently control the temperature and the flow rate of air discharged to the right side zone in a vehicle compartment.

In a ninth aspect of the present invention, the air conditioner for a vehicle in the first or fourth aspect comprises: operation mechanisms (28 to 31) each capable of controlling the first cold air door (26), the first hot air door (24), the second cold air door (27) and the second hot air door (25) independently of each other; a first temperature setting means (52a) for generating a temperature setting signal of the first air passage (18); a second temperature setting means (52b) for generating a temperature setting signal of the second air passage (19); a first air flow rate setting means (52f) for generating an air flow rate setting signal of the first air passage (18); a second air flow rate setting means (52g) for generating an air flow rate setting signal of the second air passage (19); and a control means (50) for receiving signals from the first temperature setting means (52a), the second temperature setting means (52b), the first air flow rate setting means (52f) and the second air flow rate setting means (52g) and for controlling each of the operation mechanisms (28 to 31) for each of the doors (24 to 27) independently of each other.

Because of this, it is possible to automatically control the temperature and the flow rate of air flowing in the first and second air passages (18, 19) by independently controlling the operation mechanism (28 to 31) of the doors (24 to 27) by means of the control means (50).

The symbols in the brackets attached to each means described above indicate a correspondence with a specific means in the embodiments to be described later.

The present invention may be more fully understood from the description of the preferred embodiments of the invention set forth below, together with the accompanying drawings.

### BRIEF DESCRIPTION OF THE DRAWINGS

In the drawings:

FIG. 1 is a longitudinal sectional view of an air conditioning unit in an air conditioner for a vehicle according to a first embodiment of the present invention.

FIG. 2 is a longitudinal sectional view of a fan unit according to the first embodiment.

FIG. 3 is a transverse sectional view of part of the fan unit and the air conditioning unit according to the first embodiment.

FIG. 4A is a longitudinal sectional view of a cold air mix door and a hot air mix door according to the first embodiment showing a low air flow rate state.

FIG. 4B is a longitudinal sectional view of a cold air mix door and a hot air mix door according to the first embodiment showing a high air flow rate state.

FIG. 5 is a block diagram of an electrical control unit according to the first embodiment.

FIG. 6 is a front view showing a specific example of an air conditioning panel according to the first embodiment.

FIG. 7 is a control characteristic diagram of the fan motor terminal voltage according to the first embodiment.

FIG. 8A is a characteristic diagram showing the independent adjustment of the discharged air flow rate in the vehicle left side and right side zones according to the first embodiment.

FIG. 8B is a diagram showing the independent adjustment of the discharged air flow rate in the vehicle right side zones according to the first embodiment.

FIG. 9 is a characteristic diagram of the door opening degree control when the air flow rate of one of the passages is decreased according to a second embodiment of the present invention.

FIG. 10 is a characteristic diagram of the correction control of the fan motor terminal voltage in accordance with the door opening degree control shown in FIG. 9.

FIG. 11 is a characteristic diagram of the door opening degree control when the air flow rate of one of the passages is increased according to the second embodiment.

FIG. 12 is a characteristic diagram of the correction control of the fan motor terminal voltage in accordance with the door opening degree control shown in FIG. 11.

FIG. 13 is a longitudinal sectional view of an air conditioning unit in an air conditioner for a vehicle according to a third embodiment of the present invention.

### DESCRIPTION OF THE PREFERRED EMBODIMENT

(First Embodiment)

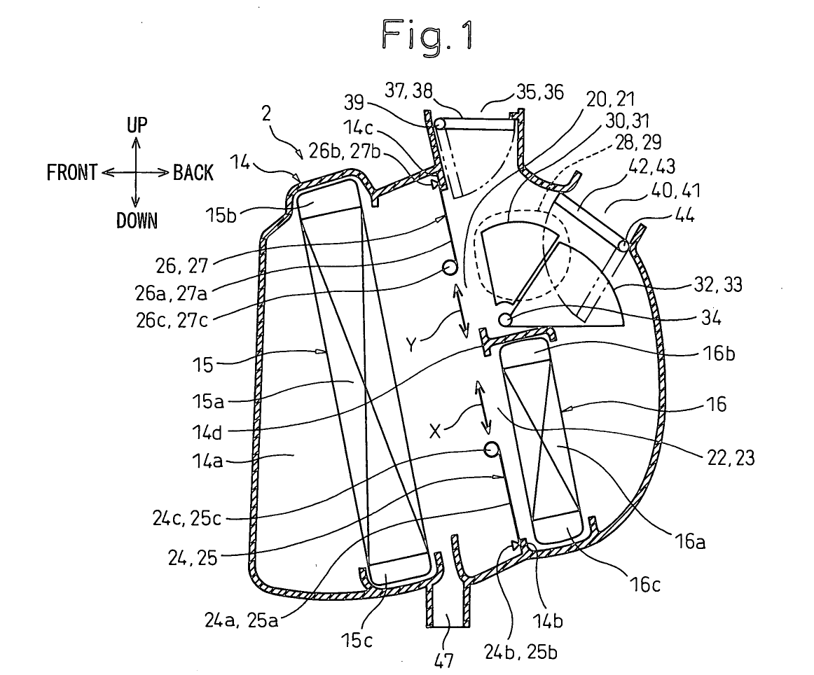

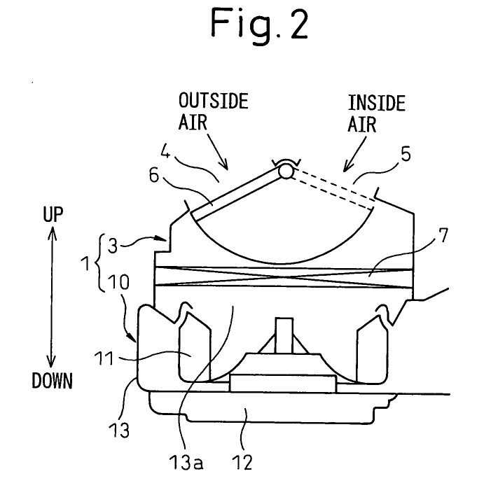

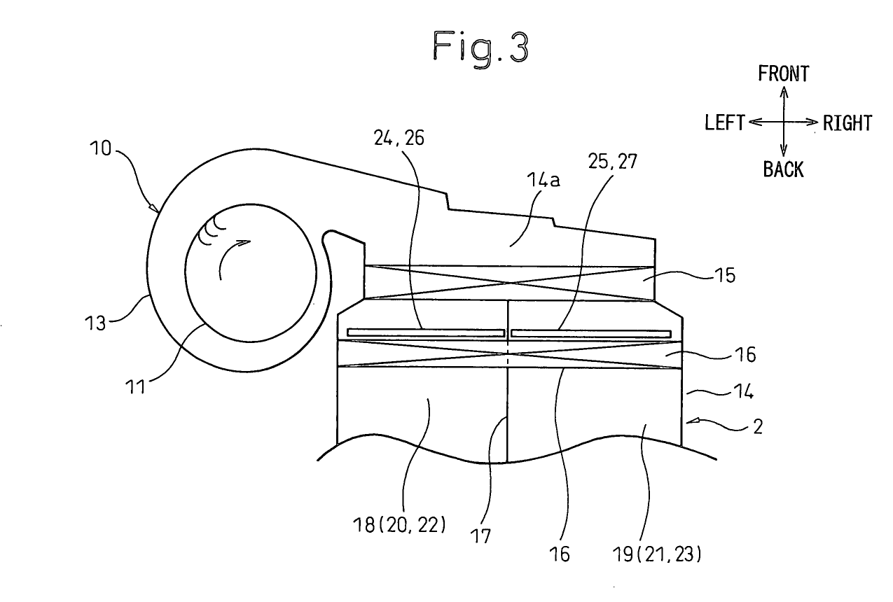

FIG. 1 is a longitudinal sectional view of an air conditioning unit 2 of an indoor unit of an air conditioner for a vehicle according to a first embodiment of the present invention and FIG. 2 is a longitudinal sectional view of a fan unit 1. FIG. 3 is a transverse sectional view showing a configuration of connection of the fan unit 1 and an upstream side of the air conditioning unit 2.

The indoor unit portion of the air conditioner for a vehicle is divided roughly into two parts that are the fan unit 1 and the air conditioning unit 2 in the present embodiment and each of the forward (front), backward, upward, downward, leftward and rightward arrows in FIG. 1 to FIG. 3 indicates the direction of the fan unit 1 and the air conditioning unit 2 when mounted on a vehicle.

The air conditioning unit 2 is arranged substantially at the center, in the transverse direction, of the vehicle inside the instrument panel at a front zone in a vehicle compartment, that is, a center placement type. Contrary to this, the fan unit 1 is arranged offset from the center and with respect to the air conditioning unit 2 and near one side, in the transverse direction, of the vehicle, that is, in front of the front passenger seat, as shown in FIG. 3. FIG. 3 shows an example of a vehicle with right-hand steering wheel, in which the front passenger seat is located on a vehicle left side.

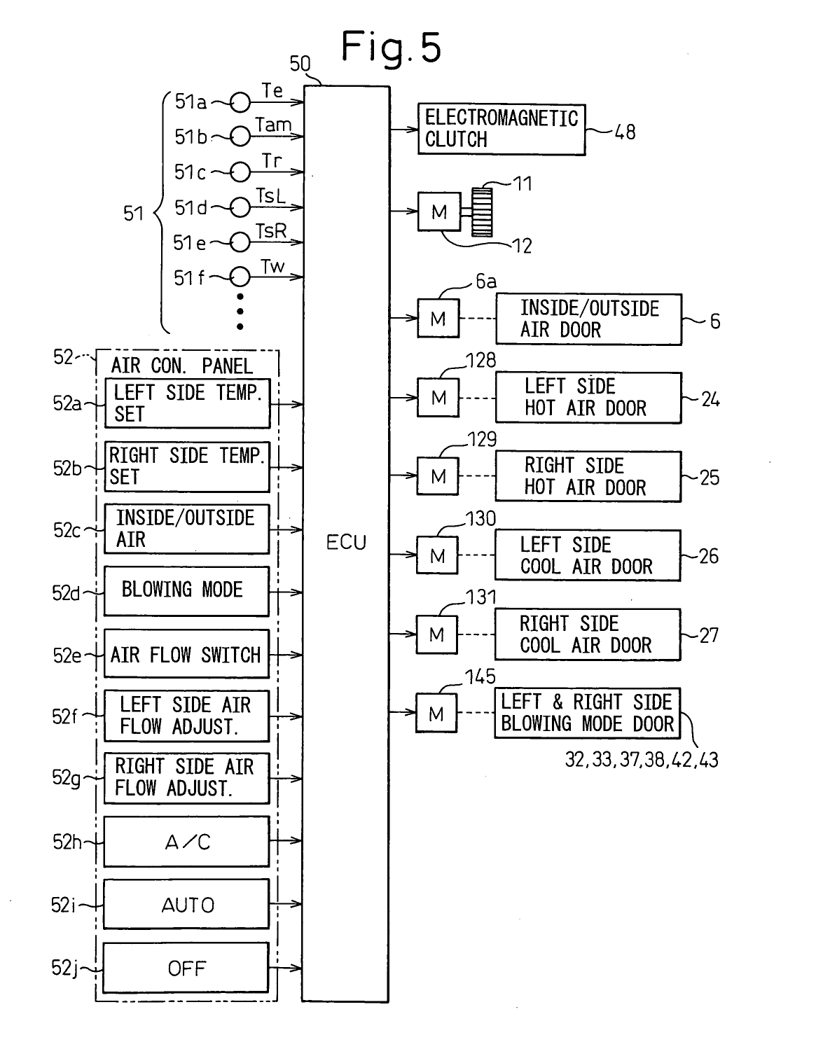

As shown in FIG. 2, the fan unit 1 has an inside/outside air switching box 3 at the upper part thereof and the inside/outside air switching box 3 is provided with an outside air introduction inlet 4, an inside air introduction inlet 5 and an inside/outside air switching door 6, and the outside air and the inside air are switched and introduced by opening and closing the outside air introduction inlet 4 and the inside air introduction inlet 5 by using the inside/outside air switching door 6. The inside/outside air switching door 6 is connected to an inside/outside air switching operation mechanism (not shown) and is rotatably operated. The inside/outside air switching operation mechanism comprises an actuator mechanism using a servomotor 6a (refer to FIG. 5, which will be described later). At the lower part of the inside/outside air switching box 3, a filter 7 is arranged for removing dust particles, offensive smells, and so on, contained in the air introduced into the inside/outside air switching box 3.

In the fan unit 1, a fan 10 is arranged under the filter 7. The fan 10 which has a widely known configuration comprises a centrifugal fan 11 made of several blade parts arranged annularly, a motor 12 for rotatably driving the centrifugal fan 11, and a vortex-shaped scroll case 13 for housing the centrifugal fan 11. At the upper part of the scroll case 13, a bell-mouth-shaped suction port 13a opens for sucking air which has passed through the filter 7.

Next, the air conditioning unit 2 is explained. The air conditioning unit 2 has a case 14 made of resin and the case 14 is normally made of two divided case bodies coupled into one unit by a proper couple-tightening means, such as a metal spring clamp on a screw, wherein the two divided (left and right) case bodies are made by dividing the case 14 in a dividing plane (not shown) located at the center of a vehicle in the transverse (width) direction. At the front part within the case 14, an air entrance space 14a is formed, to which an air exit part of the scroll case 13 is connected. Therefore, when the centrifugal fan 11 within the fan unit 1 is operated, air flows into the space 14a at the front part within the case 14.

The air sent from the fan unit 1 flows from the front side to the back side of the vehicle within the case 14 and an evaporator 15 and a heater core 16 are arranged in series in this order from the upstream side of the air flow within the case 14.

The evaporator 15 makes up a widely known refrigerating cycle together with a compressor, a condenser and a pressure reducing means, not shown here, and is a cooling heat exchanger for cooling the air within the case 14. The evaporator 15 has a configuration in which a heat exchanging core part 15a, comprising flat tubes through which a low pressure refrigerant whose pressure has been reduced by the pressure reducing means flows and corrugated fins connected to the flat tubes, are arranged between an upper tank part 15b and a lower tank part 15c.

The heater core 16 is a heating heat exchanger for heating the air within the case 14 using hot water (engine cooling water) flowing inside the vehicle as a heat source, and has a widely known configuration in which a heat exchanging core part 16a comprising flat tubes through which hot water flows and corrugated fins connected to the flat tubes, are arranged between an upper tank part 16b and a lower tank part 16c.

As shown in FIG. 3, in the case 14, the air passage on the downstream side (back side of the vehicle) of the evaporator 15 is partitioned off into two passages, that is, a vehicle left side air passage 18 and a vehicle right side air passage 19 by a center partition board 17. As described above, FIG. 3 shows a mounting example for a car with a right-hand steering wheel, therefore, the vehicle left side air passage 18 makes up a passenger seat side air passage and the vehicle right side air passage 19 makes up a driver's seat side air passage.

Next, a temperature adjusting mechanism is explained, which adjusts the temperature of the air discharged to a vehicle compartment from the vehicle left side air passage 18 and the vehicle right side air passage 19. In the temperature adjusting mechanism, the height of the heater core 16 is set to about half of the height of the evaporator 15 and the heater core is arranged in a lower space within the case 14 and, thereby a vehicle left side cold air passage 20 and a vehicle right side cold air passage 21 (refer to FIG. 1) are formed over the heater core 16 in the vehicle left side air passage 18 and the vehicle right side air passage 19, respectively. Cold air flows through the cold air passages 20 and 21 in order to bypass the heater core 16.

A vehicle left side hot air passage 22 and a vehicle right side hot air passage 23 (refer to FIG. 1) are formed in parallel with each other under the vehicle left side cold air passage 20 and the vehicle right side cold air passage 21 in the vehicle left side air passage 18 and the vehicle right side air passage 19, respectively. Both of the hot air passages 22 and 23 are passages through which hot air, heated by the heater core 19, flows.

At the upstream part of the heater core 16 in the vehicle left side air passage 18, a left side hot air mix door 24 is arranged and at the upstream part of the heater core 16 in the vehicle right side air passage 19, a right side hot air mix door 25 is arranged. At the upper part of the left side hot air mix door 24 in the vehicle left side air passage 18, a left side cold air mix door 26 is arranged and, at the upper part of the right side hot air mix door 25 in the vehicle right side air passage 19, a right side cold air mix door 27 is arranged.

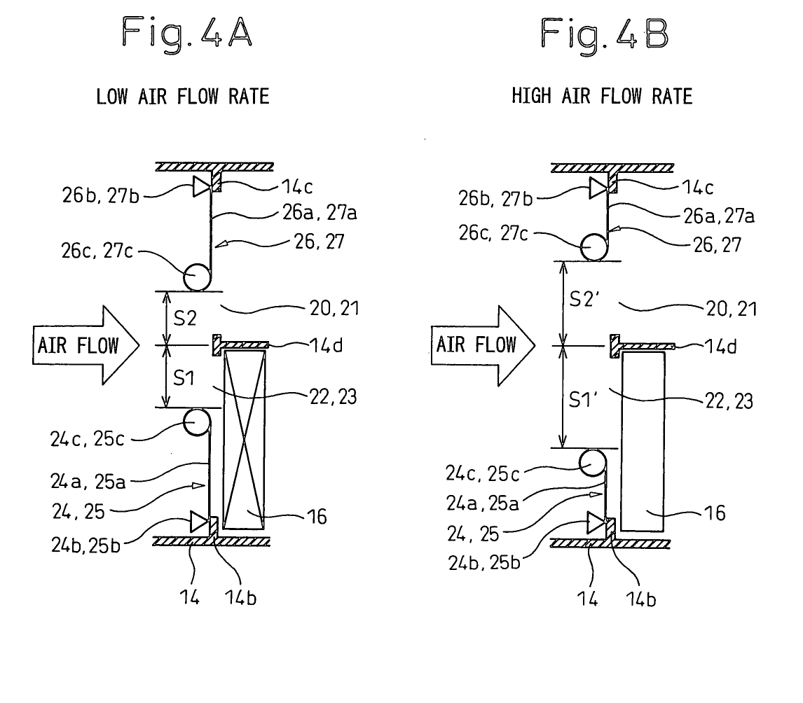

Next, a specific configuration of the left side and right side hot air mix doors 24 and 25 and the left side and right side cold air mix doors 26 and 27 are explained with reference to FIG. 4. In an example shown in FIG. 4, each of the air mix doors 24 to 27 is made of a film door having an identical configuration using each of thin film members 24a to 27a.

In the left side and right side hot air mix doors 24 and 25, ends of the thin film members 24a and 25a, that is, the lower ends thereof are fixed on a lower end 14b (part of the case 14) of the entrance opening parts of the hot air passages 22 and 23 by the use of proper fixing members 24b and 25b. In the left side and right side cold air mix doors 26 and 27, ends of the thin film members 26a and 27a, that is, the upper ends thereof are fixed on an upper end 14c (part of the case 14) of the entrance opening parts of the cold air passages 20 and 21 by the use of proper fixing members 26b and 27b.

In the left side and right side hot air mix doors 24 and 25, the other ends of the thin film members 24a and 25a, that is, the upper ends thereof are connected to winding shafts 24c and 25c and the other ends of the thin film members 24a and 25a are wound by the winding shafts 24c and 25c or the other ends of the thin film members 24a and 25a are paid out from the winding shafts 24c and 25c.

In the left side and right side cold air mix doors 26 and 27, the other ends of the thin film members 26a and 27a, that is, the lower ends thereof are connected to winding shafts 26c and 27c and the other ends of the thin film members 26a and 27a are wound by the winding shafts 26c and 27c or the other ends of the thin film members 26a and 27a are paid out from the winding shafts 26c and 27c.

Various kinds of material can be used for the thin film members 24a to 27a as long as the material is resin film material having flexibility so as to be wound by the winding shafts 24c to 27c and, for example, PET (polyethylene terephthalate) films or PPS (polyphenylene sulfide) films are preferable. The thickness of the thin film members 24a to 27a is, for example, about 200 μm.

The winding shafts 24c and 25c for hot air move, while rotating, in a vertical direction, toward or apart from the lower end 14b on which the ends of the thin film members 24a and 25a for hot air are fixed, that is, in the direction X of opening or closing the hot air passages 22 and 23 (in the vertical direction in FIG. 1). Similarly, the winding shafts 26c and 27c for cold air move, while rotating, in the direction toward or apart from the upper end 14c on which the ends of the thin film members 26a and 27a for cold air are fixed, that is, in the direction Y of opening or closing the cold air passages 20 and 21 (in the vertical direction in FIG. 1)

The winding shafts 24c and 25c for hot air and the winding shafts 26c and 27c for cold air are each connected to individual door operation mechanisms independently of each other, and the four, in total, winding shafts 24c, 25c and winding shafts 26c, 27c are moved, while rotating, in the vertical directions X and Y, respectively, independently of each other as shown in FIG. 1. The door operation mechanisms each have servomotors 28 to 31 (refer to FIG. 5, which will be described later), respectively, and by controlling the number of rotations of the servomotors 28 to 31, the number of rotations of each of the winding shafts 24c to 27c is controlled and, thereby the stop position of movement of each of the winding shafts 24c to 27c in the vertical direction, shown by X or Y in FIG. 1, is controlled.

The mechanism, which moves each of the winding shafts 24c to 27c, while rotating, in the vertical direction X or Y by means of the rotation of the servomotors 28 to 31, can be configured by the use of various mechanisms, for example, by the use of a worm gear mechanism. To be specific, the worm shafts (not shown) rotatably driven by the servomotors 28 to 31 are each arranged so as to be perpendicular to the respective winding shafts 24c to 27c, and the worm gear to be engaged with the worm of each of the worm shafts is provided on the end of each of the winding shafts 24c to 27c. Due to this, it is possible for each of the winding shafts 24c to 27c to move, while rotating, in the direction X or Y by means of the rotation of the worm shaft.

In the left side and right side hot air mix doors 24 and 25, as the winding shafts 24c and 25c for hot air move in the vertical direction X, the upper ends (the other ends) of the thin film members 24a and 25a for hot air change their positions and the opening area S1 (refer to FIG. 4) of the hot air passages 22 and 23 increases or decreases.

Similarly, in the left side and right side cold air mix doors 26 and 27, as the winding shafts 26c and 27c for cold air move in the vertical direction Y, the lower ends (the other ends) of the thin film members 26a and 27a for cold air change their positions and the opening area S2 (refer to FIG. 4) of the cold air passages 20 and 21 increases or decreases. By adjusting the ratio of the opening area S1 of the hot air passages 22 and 23 to the opening area S2 of the cold air passages 20 and 21, the proportion of the flow rate of hot air flowing through the hot air passages 22 and 23 with respect to the flow rate of cold air flowing through the cold air passages 20 and 21 can be adjusted.

In FIG. 1 and FIG. 4, a partition wall 14d partitions the cold air passages 20 and 21 from the hot air passages 22 and 23, and can be integrally formed in the case 14. When the winding shafts 24c and 25c for hot air move up to the front end of the partition wall 14d, the hot air passages 22 and 23 are fully closed by the thin film members 24a and 25a for hot air, and when the winding shafts 26c and 27c for cold air move up to the front end of the partition wall 14d, the cold air passages 20 and 21 are fully closed by the thin film members 26a and 27a for cold air.

In the vehicle left side air passage 18 and the vehicle right side air passage 19 within the case 14, air mixing parts 28 and 29 (refer to FIG. 1) are formed on the downstream side (back side of the vehicle) of the cold air passages 20 and 21, respectively, and hot air and cold air in the left side and right side air passages 18 and 19 are mixed in the left side and right side air mixing parts 28 and 29.

In the left and right side wall parts of the case 14, left side and right side foot opening parts 30 and 31 open at the portions to the left and to the right of the air mixing parts 28 and 29. Conditioned air is discharged from the left side and right side foot opening parts 30 and 31 toward the feet of a passenger. The left side and right side foot opening parts 30 and 31 are opened and closed by left side and right side foot doors 32 and 33.

The openings of the foot opening parts 30 and 31 and the foot doors 32 and 33 have the shape of a sector in the present embodiment and as the sector-shaped left side and right side foot doors 32 and 33 rotate about an axis of rotation 34 along the left side and right side wall parts of the case 14, the left side and right side foot opening pars 30 and 31 are opened or closed. In FIG. 1, when the foot doors 32 and 33 are located at the position drawn by the solid line, the foot opening parts 30 and 31 are in a fully opened state, and as the foot doors 32 and 33 rotate in the counterclockwise direction from this position drawn by the solid line, the foot opening parts 30 and 31 are closed accordingly.

Within the case 14, left side and right side defroster opening parts 35 and 36 open at the portion above the air mixing parts 28 and 29. Conditioned air is discharged from the defroster opening parts 35 and 36 toward the inner surface of the windshield in a vehicle compartment. The left side and right side defroster opening parts 35 and 36 are opened and closed by left side and right side defroster doors 37 and 38. Each of the defroster doors 37 and 38 comprises a board door rotatable about an axis of rotation 39

Moreover, within the case 14, left side and right side face opening parts 40 and 41 open in the back side wall obliquely above the air mixing parts 28 and 29. Conditioned air is discharged from the left side and right side face opening parts 40 and 41 toward the upper body of a passenger. The left side and right side face opening parts 40 and 41 are opened and closed by left side and right side face doors 42 and 43. Each of the face doors 42 and 43 comprises a board door rotatable about an axis of rotation 44.

As the present embodiment employs a system in which left side and right side blowing modes are switched in an interlocked relationship with each other, the left side and right side foot doors 32 and 33, the left side and right side defroster doors 37 and 38, and the left side and right side face doors 42 and 43 are each connected to a blowing mode operation mechanism common to the left side and right side doors 42 and 43 so that all of the left side and right side blowing mode doors 32, 33, 37, 38, 42 and 43 are operated in an interlocked relationship with each other.

The above-mentioned foot doors 32 and 33, the defroster doors 37 and 38, and the face doors 42 and 43 can be operated independently of each other in the vehicle left side air passage 18 and the vehicle right side air passage 19, respectively, and each of the left side doors 32, 37 and 42 (left side blowing mode doors) arranged within the vehicle left side air passage 18 is connected to the left side blowing mode operation mechanism and operated in an interlocked relationship with each other. Each of the right side doors 33, 38 and 43 (right side blowing mode doors) arranged within the vehicle right side air passage 19 is connected to the right side blowing mode operation mechanism and is operated in an interlocked relationship with each other.

To be more specific, the blowing mode operation mechanism common to the left side and right side doors comprises a single servomotor 45 (refer to FIG. 5, which will be described later) and a link mechanism (not shown) for transmitting the rotation of the servomotor 45 to each door described above, and each of the above-mentioned doors is opened and closed by controlling the number of rotations of the servomotor 45 via the link mechanism. In the bottom of the case 14, a drain opening 47, for draining condensed water generated by the evaporator 15, is opened.

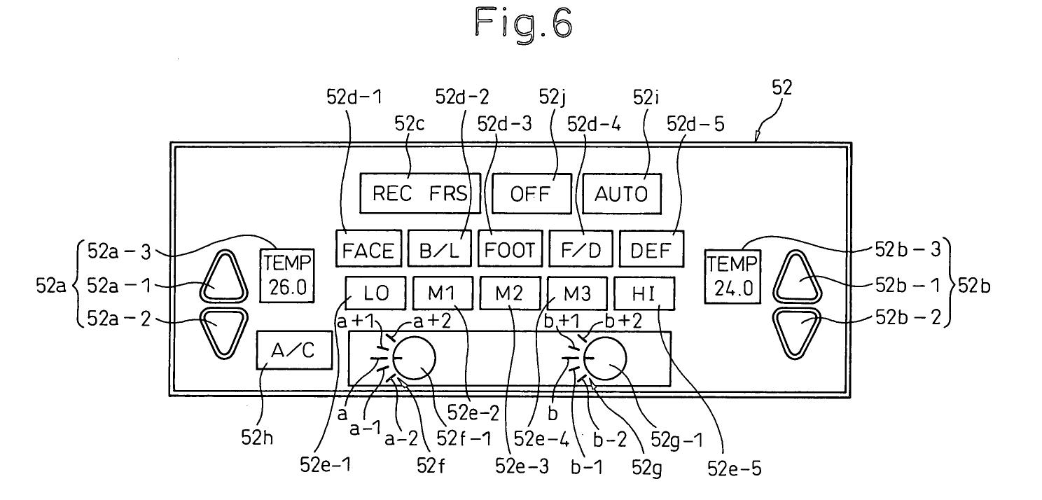

Next, the outline of the electric control section in the present embodiment is explained with reference to FIG. 5. An air conditioning control unit 50 comprises a widely known microcomputer having a CPU, ROM, RAM, etc., and peripheral circuits and the ROM stores control programs for controlling air conditioning and various calculation and processes are carried out based on the control programs. A sensor detecting signal from a sensor group 51 and an operation signal from an air conditioning panel 52 are input to the input side of the air conditioning control unit 50. FIG. 6 shows a specific example of the configuration of the air conditioning panel 52.

The sensor group 51 comprises an evaporator temperature sensor 51a for detecting a blowing air temperature Te within the evaporator 15, an outside air temperature sensor 51b for detecting an outside air temperature Tam, an inside air temperature sensor 51c for detecting an inside air temperature Tr, a left side solar radiation sensor 51d for detecting the quantity of solar radiation TsL in the left side zone in a vehicle compartment, a right side solar radiation sensor 51e for detecting the quantity of solar radiation TsL in the right side zone in a vehicle compartment, a water temperature sensor 51f for detecting a hot water temperature Tw, which flows into the heater core 16, and so on.

The air conditioning panel 52 is arranged in the vicinity of the instrument panel (not shown) in front of the driver's seat in a vehicle compartment and comprises operation switches 52a to 52j to be operated by a passenger as follows. The left side temperature setting switch 52a sends out a signal for a set temperature TsetL in the left side zone in a vehicle compartment. The right side temperature setting switch 52b sends out a signal for a set temperature TsetR in the right side zone in a vehicle compartment.

In a specific example in FIG. 6, the left side and right side temperature setting switches 52a and 52b have temperature increasing knobs 52a-1 and 52b-1, temperature decreasing knobs 52a-2 and 52b-2, and set temperature display units 52a-3 and 52b-3, respectively.

The inside/outside air switching switch 52c sends out a signal for manually setting the inside air mode and the outside air mode by using the inside/outside switching door 6.

The blowing mode switch 52d sends out a signal for manually setting a face mode, bilevel mode, foot mode, foot defroster mode and defroster mode widely known as blowing modes for blowing air into the left side and right side zones in a vehicle compartment from the vehicle left side air passage 18 and the vehicle right side air passage 19. The air flow rate switching switch 52e sends out a signal for manually setting a face mode, bilevel mode, foot mode, foot defroster mode and defroster mode widely known as blowing modes for blowing air into the right side zone in a vehicle compartment from the vehicle right side air passage 19.

The left side air flow rate setting switch 52f sends out a signal for manually adjusting the flow rate of air discharged (blowing) to the left side zone in a vehicle compartment from the vehicle left side air passage 18 and the right side air flow rate adjusting switch 52g sends out a signal for manually adjusting the flow rate of air discharged to the right side zone in a vehicle compartment from the vehicle right side air passage 19. To be specific, as the left side and right side air flow rate setting switches 52f and 52g, it is possible to use, for example, a switch which directly sends out an air flow rate switching signal such as a signal for a low air flow rate (Lo), a signal for a first intermediate air flow rate (Me1), a signal for a second intermediate air flow rate (Me2), and a signal for a high air flow rate (Hi), or a switch which sends out signals for increasing or decreasing the air flow rate step by step from the air flow rate in accordance with the currently set level. Therefore, operation knobs 52d-1 to 52d-5, in accordance with the respective modes are provided independently of each other in a specific example shown in FIG. 6.

The air flow rate switching switch 52e sends out a signal for changing the terminal voltage of the motor 12 for driving the fan 10 and switches to increase or decrease the air flow rate of the fan 10 by changing the number of rotations of the fan 10 by changing the motor terminal voltage of the fan 10.

In the specific example shown in FIG. 6, the air flow rate switching switch 52e comprises a low air flow rate knob 52e-2 for sending out a signal for a low air flow rate (Lo), a first intermediate air flow rate knob 52e-2 for sending out a signal for a first intermediate air flow rate (M1) higher than the low air flow rate (Lo) by a predetermined flow rate increase, a second intermediate air flow rate knob 52e-3 for sending out a signal for a second intermediate air flow rate (M2) higher than the first intermediate air flow rate (M1) by a predetermined flow rate increase, a third intermediate air flow rate knob 52e-4 for sending out a signal for a third intermediate air flow rate (M3) higher than the second intermediate air flow rate (M2) by a predetermined flow rate increase, and a high air flow rate knob 52e-5 for sending out a signal for a high air flow rate (Hi) higher than the third intermediate air flow rate (M3) by a predetermined air flow rate increase.

The left side air flow rate quantity adjusting switch 52f sends out a signal for independently adjusting only the flow rate of air discharged to the left side zone in a vehicle compartment from the vehicle left side air passage 18 in accordance with the preference of a passenger. Similarly, the right side air flow rate adjusting switch 52g sends out a signal for independently adjusting only the flow rate of air blowing into the right side zone in a vehicle compartment from the right side air passage 19 in accordance with the preference of a passenger.

In the specific example shown in FIG. 6, the left side and right side air flow rate adjusting switches 52f and 52g each have rotary operation knobs 52f-1 and 52g-1, respectively, and the rotary operation knobs 52f-1 and 52g-1 are provided with marked positions as operation positions: reference air flow rate positions a and b for sending out a reference air flow rate signal; first air flow rate increasing positions a+1 and b+1 for sending out a first air flow rate increasing signal for a higher air flow rate than the reference air flow rate by a predetermined flow rate increase; second air flow rate increasing positions a+2 and b+2 for sending out a second air flow rate increasing signal for a still higher air flow rate than the first increased air flow rate by a predetermined air flow increase; first air flow rate decreasing positions a−1 and b−1 for sending out a first air flow rate decreasing signal for a lower air flow rate than the reference air flow rate by a predetermined flow rate decrease; and second air flow rate decreasing positions a−2 and b−2 for sending out a second air flow rate decreasing signal for a still lower air flow rate than the first decreased air flow rate by a predetermined flow rate decrease.

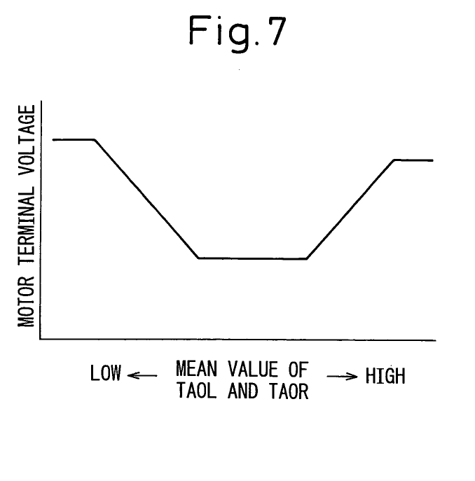

The above-mentioned reference air flow rate is determined based on the control characteristic of the motor terminal voltage of the fan 10 (refer to FIG. 7), which will be described later.

The air conditioning switch 52h intermittently starts and terminates the operation of a compressor of a refrigerating cycle type (not shown) provided with the evaporator 15 by sending out signals for turning on and off the current to an electromagnetic clutch 48 of the compressor. The automatic switch 52i sends out a command signal for automatic control of the air conditioning operation and the off switch 52j sends out a stop signal for stopping the air conditioning operation.

To the output side of the air conditioning control unit 50, units, such as the electromagnetic clutch 48 of the compressor, the motor 12 for driving the fan 10, the servomotors 6a, 128 to 131 and 145, which are electrically driving means for each unit, and so on, are connected and the operations of these units are controlled by the output signal of the air conditioning control unit 50.

Next, the operations in the present embodiment in the configuration described above are explained. The air conditioning unit 50 reads the detecting signal of the sensor group 51, the operation signal of the air conditioning panel 52, etc., and calculates the target blowing (discharged) temperature TAOL of the air discharged into the left side zone in a vehicle compartment from the vehicle left side air passage 18 and the target blowing (discharged) temperature TAOR of the air discharged into the right side zone in a vehicle compartment from the vehicle right side air passage 19.

The left side target blowing temperature TAOL is a discharged (blowing) air temperature required for keeping the left side zone in a vehicle compartment at the left side set temperature TsetL set by the left side temperature setting switch 52a, regardless of the fluctuations of the thermal load on the air conditioning and, similarly, the right side target blowing temperature TAOR is a discharged air temperature required for keeping the right side zone in a vehicle compartment at the right side set temperature TsetR set by the right side temperature setting switch 52b, regardless of the fluctuations of the thermal load on the air conditioning.

The above-mentioned left side target blowing temperature TAOL is calculated, as widely known, based on the left side set temperature TsetL and the outside air temperature Tam, the inside air temperature Tr and the quantity of solar radiation TsL in the left side zone, detected by the sensors 51b, 51c and 51d, respectively. Similarly, the right side target blowing temperature TAOR is calculated based on the right side set temperature TsetR and the outside air temperature Tam, the inside air temperature Tr and the quantity of solar radiation TsR in the right side zone, detected by the sensors 51b, 51c and 51d, respectively.

The air conditioning control unit 50 controls the temperature of the air discharged from the vehicle left side air passage 18 into the left side zone in a vehicle compartment so as to be adjusted to the left side target blowing temperature TAOL by determining the target operation positions of the left side hot air mix door 24 and the left side cold air mix door 26 arranged in the vehicle left side air passage 18, respectively, based on the left side target blowing temperature TAOL, the discharged air temperature Te of the evaporator and the hot water temperature Tw and by controlling the operation positions of the left side hot air mix door 24 and the left side cold air mix door 26 so as to be adjusted to the above-mentioned target operation positions.

Similarly, the air conditioning control unit 50 controls the temperature of the air discharged from the vehicle right side air passage 19 into the right side zone in a vehicle compartment so as to be adjusted to the right side target blowing temperature TAOR by determining the target operation positions of the right side hot air mix door 25 and the right side cold air mix door 27 arranged in the vehicle right side air passage 19, respectively, based on the right side target blowing temperature TAOR, the discharged air temperature Te of the evaporator and the hot water temperature Tw and by controlling the operation positions of the right side hot air mix door 25 and the right side cold air mix door 27 so as to be adjusted to the above-mentioned target operation positions.

The temperature control of the air discharged to the left side zone by means of the left side hot air mix door 24 and the left side cold air mix door 26 will be explained more specifically by taking the vehicle left side air passage 18 as an example. In order to set a maximum cooling state in which the air discharged to the left side zone is cooled to the maximum based on the left side target blowing temperature TAOL calculated by the air conditioning control unit 50, the winding shaft 26c of the left side cold air mix door 26 is shifted to the uppermost position by the rotation of the servomotor 30. In other words, the winding shaft 26c is shifted to the position closest to the fixing position of the upper end (the position of the fixing member 26b) of the thin film member 26a.

At this time, the winding shaft 26c moves upward while rotating in the clockwise direction in FIG. 1. Due to this, the thin film member 26a is brought into a state of being wound to the maximum by the winding shaft 26c and the left side cold air passage 20 is fully opened by the left side cold air mix door 26.

At the same time, the winding shaft 24c of the left side hot air mix door 24 is shifted to the uppermost position (the position of the front end of the partition wall 14d) by the rotation of the servomotor 28. In other words, the winding shaft 24c is shifted to the position furthest from the fixing position of the lower end (the position of the fixing member 24b) of the thin film member 24a. At this time, the winding shaft 24c moves upward while rotating in the clockwise direction in FIG. 1. Due to this, the film member 24a is brought into a state of being paid out (rewound) to the maximum from the winding shaft 24c and the left side hot air passage 22 is fully closed by the thin film member 24a.

As a result, in the vehicle left side air passage 18, the entire quantity of the cold air cooled in the evaporator 15 passes through the cold air passage 20 and is discharged from the left side blowing opening parts, 35 and 40 into the left side zone in a vehicle compartment, therefore, the maximum cooling performance can be attained in the left side zone in a vehicle compartment. During the maximum cooling operation, the face mode is usually selected and, therefore, the cold air is discharged from the left side face opening part 40 toward the upper body of a passenger in the left side zone in a vehicle compartment.

Next, in order to set a maximum heating state in which the air blowing into the left side zone is heated to the maximum based on the left side target blowing temperature TAOL calculated by the air conditioning control unit 50, the winding shaft 26c of the left side cold air mix door 26 is shifted to the lowermost position (the position of the front end of the partition wall 14d) by the rotation of the servomotor 30. In other words, the winding shaft 26c is shifted to the position furthest from the fixing position of the upper end (the position of the fixing member 26b) of the thin film member 26a.

At this time, the winding shaft 26c moves downward while rotating in the counterclockwise direction in FIG. 1. Due to this, the thin film member 26a is brought into a state of being paid out (rewound) to the maximum from the winding shaft 26c and the left side cold air passage 20 is fully closed by the left side cold air mix door 26.

At the same time, the winding shaft 24c of the left side hot air mix door 24 is shifted to the lowermost position by the rotation of the servomotor 128. In other words, the winding shaft 24c is shifted to the position closest to the fixing position of the lower end (the position of the fixing member 24b) of the thin film member 24a. At this time, the winding shaft 24c moves downward while rotating counterclockwise in FIG. 1. Due to this, the film member 24a is brought into a state of being wound to the maximum by the winding shaft 24c and the left side hot air passage 22 is fully opened by the thin film member 24a.

As a result, in the vehicle left side air passage 18, the entire quantity of the air having passed through the evaporator 15 flows into the left side hot air passage 22 and is heated by the heater core 16 to become hot air and is discharged from the left side blowing opening parts 35 and 40 into the left side zone in a vehicle compartment and, therefore, the maximum heating performance can be attained in the left side zone in a vehicle compartment. During the maximum heating operation, the foot mode is usually selected and, therefore, the hot air blows from the left side foot opening part 28 toward the foot part of a passenger in the left side zone in a vehicle compartment.

After air conditioning starts and a constant state of air conditioning is reached in a certain period of time, or in seasons of moderate temperature, such as spring and autumn, the temperature of the air discharged to the left side zone in a vehicle compartment is controlled so as to be adjusted to within an intermediate temperature range. In this case, the left side target blowing temperature TAOL is in an intermediate temperature range between the low temperature range for setting the above-mentioned maximum cooling state and the high temperature range for setting the above-mentioned maximum heating state, and based on the TALO in the intermediate temperature range, the winding shaft 24c of the left side hot air mix door 24 and the winding shaft 26c of the left side cold air mix door 26 are each shifted to a position of an intermediate opening degree (refer to FIG. 1) of the left side hot air passage 22 and the left side cold air passage 20, respectively.

Due to this, the ratio of the opening area S1 of the left side hot air passage 22 to the opening area S2 of the left side cold air passage 20 can be set to a predetermined ratio according to TAOL and, therefore, the temperature of the air blowing into the left side zone can be controlled so as to be adjusted to a desired intermediate temperature by adjusting the proportion of the flow rate of hot air with respect to that of cold air.

The control of the discharged air temperature in the vehicle left side air passage 18 is described above, but the discharged air temperature in the vehicle right side air passage 19 can be controlled independently by similar operations.

Next, the independent control of the air flow rate in the vehicle left side air passage 18 and the vehicle right side air passage 19 is explained with reference to FIG. 4. FIG. 4 shows the case where the air flow rate of one of the passages 18 and 19, for example, of only the left side air passage 18 is changed, wherein FIG. 4A shows a state of a low air flow rate and FIG. 4B shows a state of a high air flow rate.

In other words, in FIG. 4A, the temperature of the air blowing into the left side zone is controlled so as to be adjusted to a predetermined intermediate temperature by shifting the winding shaft 24c of the left side hot air mix door 24 and the winding shaft 26c of the left side cold air mix door 26 to a predetermined intermediate position, respectively, and by setting the ratio α (α=S1/S2) to a predetermined ratio, where the opening area of the left side hot air passage 22 is assumed to be S1 and the opening area of the left side cold air passage 20 is assumed to be S2.

Contrary to this, in FIG. 4B, the winding shaft 24c of the left side hot air mix door 24 and the winding shaft 26c of the left side cold air mix door 26 are each shifted, respectively, to positions at which the opening areas of the passages are increased compared with the position in FIG. 4A. In other words, the opening area of the left side hot air passage 22 is increased from S1 to S1′ and the opening area of the left side cold air passage 20 is increased from S2 to S2′. At this time, the opening areas of both the passages 22 and 20 are increased while the ratio of area a is maintained, that is, the relationship (S1/S2)=(S1′/S2′) is maintained.

Therefore, it is possible to change only the air flow rate in the vehicle left side air passage 18 by changing only the passage area of the vehicle left side air passage 18 without changing the temperature of the air flow in the vehicle left side air passage 18. In FIG. 4A, the passage area of the vehicle left side air passage 18 is increased and the flow rate of discharged air can be set low. In FIG. 4B, the passage area of the vehicle left side air passage 18 is increased and the flow rate of discharged air can be set high.

At this time, as the left side hot air mix door 24 and the left side cold air mix door 26 change only the passage area of the vehicle left side air passage 18 and do not change the passage area of the vehicle right side air passage 19, it is possible to keep the change in the flow rate of air in the vehicle right side air passage 19 small even when the air flow rate in the vehicle left side air passage 18 changes.

In the vehicle right side air passage 19, it is also possible, following the same procedure as described above, to change only the air flow rate in the vehicle right side by increasing or decreasing the passage areas of both the passages 23 and 21 by changing the operation positions of the right side hot air mix door 25 and the right side cold air mix door 27 while maintaining the ratio of the opening area of the right side hot air passage 23 to that of the right side cold air passage 21 constant.

The independent control of the air flow rate in the vehicle left side air passage 18 and the vehicle right side air passage 19 is carried out in such a way that when a manual operation signal for increasing or decreasing the air flow rate in the vehicle left side is sent out from the left side air flow rate adjusting switch 52f installed on the air conditioning panel 52, or when a manual operation signal for increasing or decreasing the air flow rate in the vehicle right side is sent out from the right side air flow rate adjusting switch 52g, the manual operation signal is judged in the air conditioning control unit 50 and the air flow rate in each of the passages 18 and 19 is increased or decreased, in accordance with the preference of a passenger, by changing the operation position of each door following the same procedure as described above.

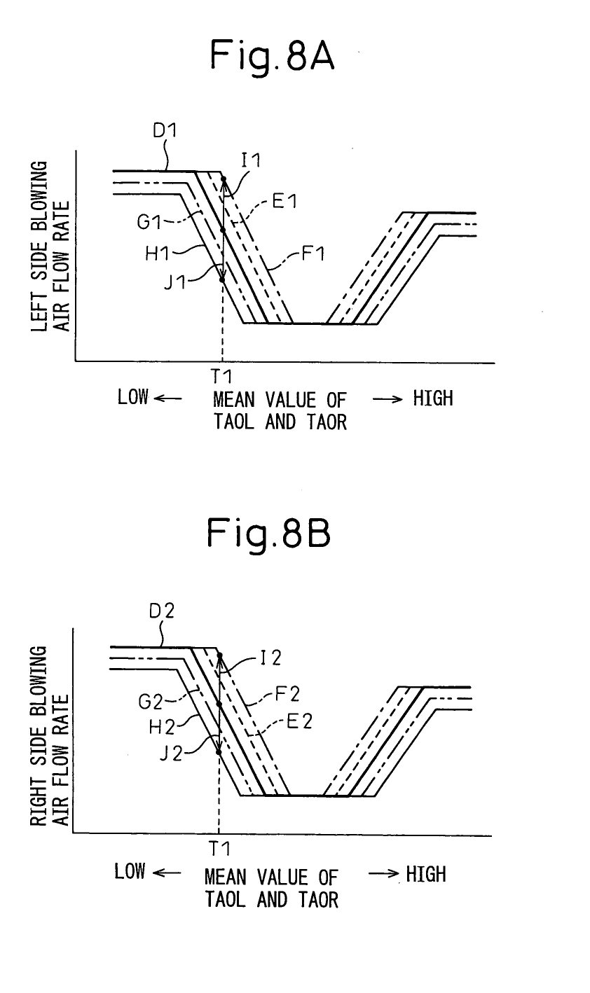

The operation to increase or decrease the air flow rate in each of the passages 18 and 19 is explained more specifically based on the control characteristic shown in FIG. 7 and FIG. 8. FIG. 7 shows a relationship between the terminal voltage of the motor 12 for driving the fan 10 and the mean value of the left side target blowing temperature TAOL and the right side target blowing temperature TAOR, described above, and the motor terminal voltage is calculated by the air conditioning control unit 50 so that the motor terminal voltage reaches the maximum value when the mean value of TAOL and TAOR is in the range of lower temperatures and in the range of higher temperatures and the motor terminal voltage falls to the minimum value when the mean value of TAOL and TAOR is in an intermediate temperature range.

The rotational speed of the motor for driving increases or decreases as the motor terminal voltage of the fan 10 increases or decreases and, as a result, the air flow rate of the fan 10 increase or decreases and, therefore, the air flow rate of the fan 10 is automatically controlled in accordance with the levels of TAOL and TAOR so that the air flow rate of the fan 10 reaches the maximum air flow rate (Hi) when the mean value of TAOL and TAOR is in the range of lower temperatures and in the range of higher temperatures, and the air flow rate of the fan 10 reaches the minimum air flow rate (Lo) when the mean value of TAOL and TAOR is in the range of intermediate temperatures.

As the air flow rate required for the maximum heating operation is generally lower than the air flow rate required for the maximum cooling operation, the maximum value of the motor terminal voltage when the mean value of TAOL and TAOR is in the range of higher temperatures is set lower, than the maximum value of the motor terminal voltage when the mean value thereof is in the range of lower temperatures, by a predetermined voltage in the control characteristic of the fan motor terminal voltage shown in FIG. 7.

On the other hand, FIG. 8A shows the control characteristic of the flow rate of air discharged from the vehicle left side air passage 18 and FIG. 8B shows the control characteristic of the flow rate of air discharged from the vehicle right side air passage 19. The horizontal axis in FIG. 8A and FIG. 8B denotes the mean value of TAOL and TAOR as in FIG. 7.

In FIG. 8A and FIG. 8B, bold solid lines D1 and D2 show the control characteristics of the reference air flow rate determined based on the control characteristic of the motor terminal voltage in FIG. 7. To be more specific, as the single fan 10 supplies air to the vehicle left side and right side air passages 18 and 19 in the present embodiment, half of the air flow rate of the fan 10 determined based on the control characteristic of the motor terminal voltage in FIG. 7 is the reference air flow rate shown by the control characteristics D1 and D2 in FIG. 8A and FIG. 8B.

When the rotary operation knobs 52f-1 and 52g-1 of the left side air flow rate adjusting switch 52f and the right side air flow rate adjusting switch 52g are operated to be located at the reference air flow rate positions a and b, at the reference air flow rate determined based on the control characteristics D1 and D2 air is discharged from the left side and right side air passages 18 and 19.

When the rotary operation knob 52f-1 of the left side air flow rate adjusting switch 52f is operated to be located at the first air flow rate increasing position a+1, the first air flow rate increasing signal is input to the air conditioning control unit 50 from the switch 52f and, therefore, the air conditioning control unit 50 calculates the increase in the passage area of the vehicle left side air passage 18 in accordance with the first air flow rate increasing signal and shifts the operation positions of the left side hot air mix door 24 and the left side cold air mix door 26 to positions which satisfy the above-mentioned increase in the passage area. Due to this, the control characteristic of the of air flow rate from the vehicle left side air passage 18 changes from the control characteristic D1 of the reference air flow rate to a first air flow rate increasing characteristic E1, the air flow rate of which is higher than that of D1 by a predetermined flow rate increase.

Next, when the rotary operation knob 52f-1 of the left side air flow rate adjusting switch 52f is operated to be located at the second air flow rate increasing position a+2, the second air flow rate increasing signal is input to the air conditioning control unit 50 from the switch 52f and, therefore, the air conditioning control unit 50 calculates the increase in the passage area of the vehicle left side air passage 18 in accordance with the second air flow rate increasing signal and shifts the operation positions of the left side hot air mix door 24 and the left side cold air mix door 26 to positions which satisfy the above-mentioned increase in the passage area. Due to this, the control characteristic of the flow rate of air discharged from the vehicle left side air passage 18 changes from the first air flow rate increasing characteristic E1 to a second air flow rate increasing characteristic F1, the air flow rate of which is higher than that of E1 by a predetermined flow rate increase.

On the other hand, when the rotary operation knob 52f-1 of the left side air flow rate adjusting switch 52f is operated to be located at the first air flow rate decreasing position a−1, the first air flow rate decreasing signal is input to the air conditioning control unit 50 from the switch 52f and, therefore, the air conditioning control unit 50 calculates the decrease in the passage area of the vehicle left side air passage 18 in accordance with the first air flow rate decreasing signal and shifts the operation positions of the left side hot air mix door 24 and the left side cold air mix door 26 to positions which satisfy the above-mentioned decrease in the passage area. Due to this, the control characteristic of the air flow rate from the vehicle left side air passage 18 changes from the control characteristic D1 of the reference air flow rate to a first air flow rate decreasing characteristic G1, the air flow rate of which is lower than that of D1 by a predetermined flow rate decrease.

Next, when the rotary operation knob 52f-1 of the left side air flow rate adjusting switch 52f is operated to be located at the second air flow rate decreasing position a−2, the second air flow rate decreasing signal is input to the air conditioning control unit 50 from the switch 52f and, therefore, the air conditioning control unit 50 calculates the decrease in the passage area of the vehicle left side air passage 18 in accordance with the second air flow rate decreasing signal and shifts the operation positions of the left side hot air mix door 24 and the left side cold air mix door 26 to positions which satisfy the above-mentioned decrease in the passage area. Due to this, the control characteristic of the air flow rate from the vehicle left side air passage 18 changes from the first air flow rate decreasing characteristic G1 to a second air flow rate decreasing characteristic H1, the air flow rate of which is lower than that of G1 by a predetermined flow rate decrease.

By following the procedure described above, it is possible to independently increase or decrease the air flow rate from the vehicle left side air passage 18 in accordance with the preference of a passenger.

In the vehicle right side air passage 19 also, it is possible to independently increase or decrease the air flow rate in accordance with the preference of a passenger by selecting the operation position of the rotary operation knob 52g-1 of the right side air flow rate adjusting switch 52g.

Arrows I1 and I2 in FIG. 8A and FIG. 8B show the increases in air flow rate for the control characteristics F1 and F2 when the mean value of TAOL and TAOR=T1. Contrary to this, arrows J1 and J2 show the decreases in air flow rate for the control characteristics H1 and H2 when the mean value of TAOL and TAOR=T1.

Although FIG. 7 shows a case where the fan motor terminal voltage is determined based on the mean value of TAOL and TAOR, the fan motor terminal voltage based on TAO on the driver's seat side (TAOR in the case of a car with right-hand steering wheel) may be determined, for example, when the automatic air conditioning control is carried out with precedence being given to the air conditioning in the driver's seat side zone over the other zone in a vehicle compartment.

In the above-mentioned explanation of the operations, the air flow rate from the left side and right side air passages 18 and 19 is increased or decreased according to the operation positions of the left side and right side air flow rate adjusting switches 52f and 52g manually operated by a passenger, but as the air conditioning control unit 50 independently calculates the target blowing temperature TAOL in the vehicle left side air passage 18 and the target blowing temperature TAOR in the vehicle right side air passage 19, when either one of the left side target blowing temperature TALO and the right side target blowing temperature TAOR is judged to have changed abruptly, the air flow rate from each of the passages 18 and 19 may be increased or decreased by automatically increasing or decreasing the passage area of each of the passages 18 and 19 based on the abrupt change in TAOL or TAOR.

The abrupt change in the left side target blowing temperature TAOL and the right side target blowing temperature TAOR is caused by an abrupt change in the set temperature TsetL or TsetR, an abrupt change in the quantity of left side solar radiation TsL or the quantity of right side solar radiation TsR, and so on.

As can be understood from the explanation given above, according to the present embodiment, it is possible to independently change the air flow rate in one of the vehicle left side air passage 18 and the vehicle right side air passage 19 while keeping slight the change in the air flow rate in the other passage.

Moreover, it is possible to independently change the air flow rate in each of the left side and the right side passages 18 and 19 by using the air mix doors 24 to 27 which carry out the function for controlling the discharged air temperature without any additional means and, therefore, it is not necessary to provide a dedicated door means for changing the air flow rate and the cost of the product can be reduced and the size of the air conditioning unit 2 can be made more compact, resulting in a considerable advantage in practical use.

(Second Embodiment)

In the first embodiment, when the air flow rate in one of the vehicle left side air passage 18 and the vehicle right side air passage 19 is changed by changing the operation positions of one the hot air mix doors 24 and 25 and one of the cold air mix doors 26 and 27 in one of the passages 18 and 19, the operating positions of the other of the hot air mix doors 24 and 25 and the other of the cold air mix doors 26 and 27 in the other of the passages 18 and 19 are not changed, but maintain the current positions thereof and, thereby, the change in the air flow rate in the other passage is kept small, but in the second embodiment, when the air flow rate in one of the passages is changed by changing the door operation positions in the passage, the change in the air flow rate in the other passage is prevented by correcting the air flow rate of the fan 10 in an interlocked relation with the change in the door operation position, that is, the change in the passage area.

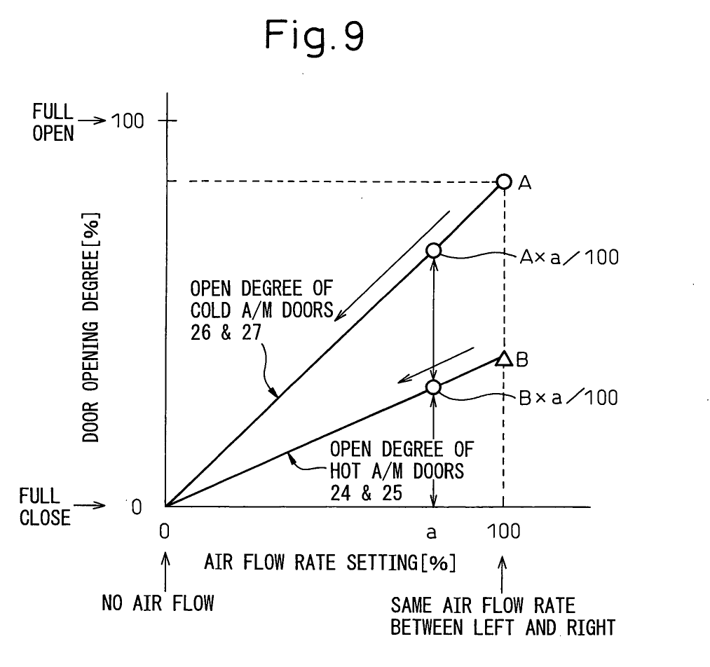

The interlocked control between the door operation positions and the air flow rate of the fan (number of rotations of the fan) according to the second embodiment is explained below specifically with reference to FIG. 9 to FIG. 12. FIG. 7 shows the relationship between the terminal voltage of the motor 12 for driving the fan 10 and the mean value of the left side target blowing temperature TAOL and the right side target blowing temperature TAOR as described above.

FIG. 9 shows the changes in the opening degree of the hot air mix doors 24 and 25 and the cold air mix doors 26 and 27 when the air flow rate of each of the left side and right side passages 18 and 19 is changed while the discharged air temperature is maintained to be constant. The increase and decrease in the opening degree of the hot air mix doors 24 and 25 mean the increase and decrease in the above-mentioned opening area S1 of the hot air passages 22 and 23 and the increase and decrease in the opening degree of the cold air mix doors 26 and 27 mean the increase and decrease in the above-mentioned opening area S2 of the cold air passages 20 and 21.

In FIG. 9, the air flow rate setting=100% on the horizontal axis represents a state in which the respective air flow rates in the left side and right side passages 18 and 19 are the same, which is automatically controlled by the motor terminal voltage shown in FIG. 7, and the air flow rate setting=0% on the horizontal axis represents a state in which the air flow rates in the left side and right side passages 18 and 19 are each zero.

In the example shown in FIG. 9, when the air flow rate setting=100%, the opening degree of the cold air mix doors 26 and 27=A % and the opening degree of the hot air mix doors 24 and 25=B %. In this state, when the air flow rate of one of the left side and right side passages 18 and 19, for example, the air flow rate of only the left side air passage 18 is decreased to a %, which is less than 100% (for example, 80%), the opening degree of the left side cold air mix door 26 is decreased to A×(a/100)% and the opening degree of the left side hot air mix door 24 is decreased to B×(a/100)%.

Due to this, it is possible to decrease the air flow rate in the left side air passage 18 to a % by decreasing the passage area of the left side air passage 18 while maintaining the ratio of the opening area of the left side hot air passage 22 to the opening area of the left side cold air passage 20 to be constant.

At this time, the opening area of the hot air passage 23 and the opening area of the cold air passage 21 of the right side air passage 19 do not change but remain the same as before but, if the air flow rate of the fan 10 is constant, the air flow rate in the right side air passage 19 tends to increase because of the influence of the decrease in the air flow rate in the left side air passage 18. To avoid this, the total air flow rate in the left side and right side passages 18 and 19, that is, the air flow rate of the fan 10 is corrected so as to be decreased by the flow rate decrease in accordance with the air flow rate decrease in the left side air passage 18.

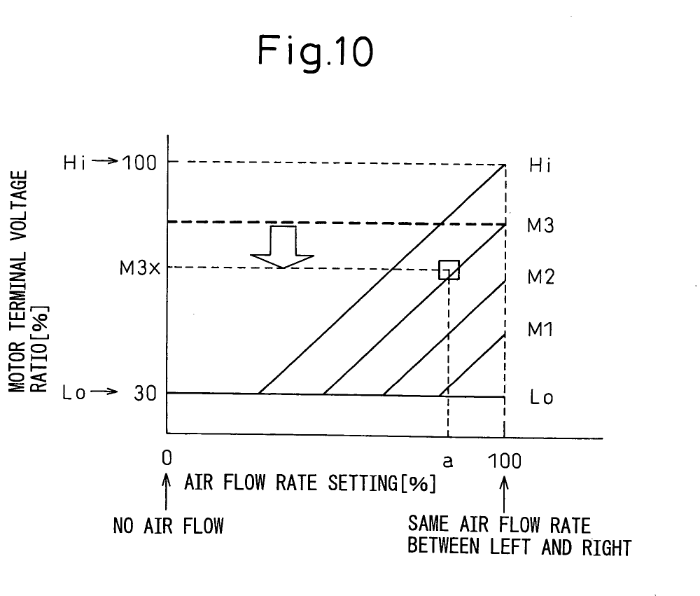

FIG. 10 shows a specific example of the correction control for decreasing the air flow rate of the fan 10. The horizontal axis in FIG. 10 represents the air flow rate as in FIG. 9 and, in the example shown in FIG. 10, when the air flow rate setting=100%, the motor terminal voltage of the fan 10 is at the M3 level by the characteristic control shown in FIG. 7. When the air flow rate of only the left side air passage 18 is decreased to a %, which is less than 100%, as described above, the motor terminal voltage of the fan 10 is lowered from the M3 level to the M3x level. M3x can be expressed by the following equation 1.

M3x=M3x{0.5+0.5×(a/100)} (Equation 1)

When the motor terminal voltage of the fan 10 is lowered from the M3 level to the M3x level, the total air flow rate in the left side and right side passages 18 and 19 can be decreased by the flow rate decrease corresponding to the air flow rate decrease in the left side air passage 18 and a change in the air flow rate in the right side air passage 19 can be avoided.

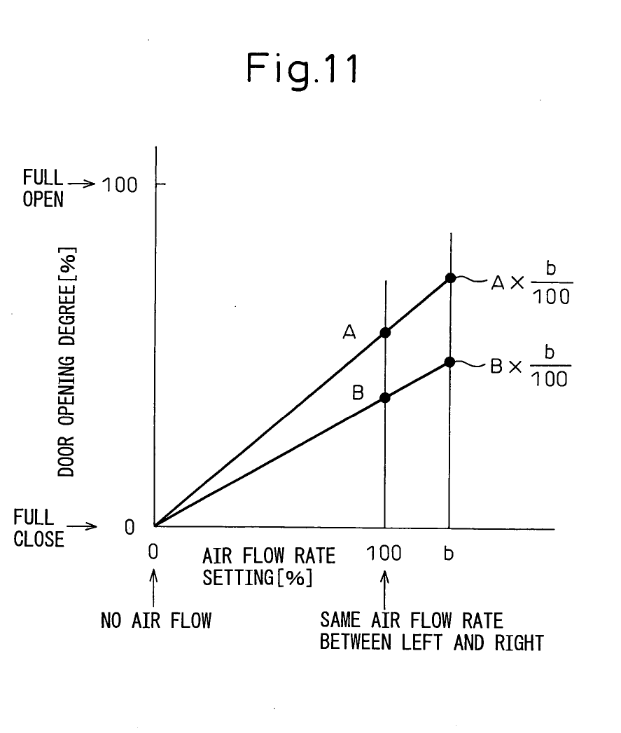

FIG. 11 is a diagram corresponding to FIG. 9, showing a case where the air flow rate in only the left side air passage 18 is increased to b %, which is greater than 100% (for example, 120%). In this case, the opening degree of the left side cold air mix door 26 is increased to A×(b/100)% and the opening degree of the left side hot air mix door 24 is increased to B×(b/100)%.

Due to this, it is possible to increase the air flow rate in the left side air passage 18 to b % by increasing the passage area of the left side air passage 18 while maintaining the ratio of the opening area of the left side hot air passage 22 to the opening area of the left side cold air passage 20 to be constant.

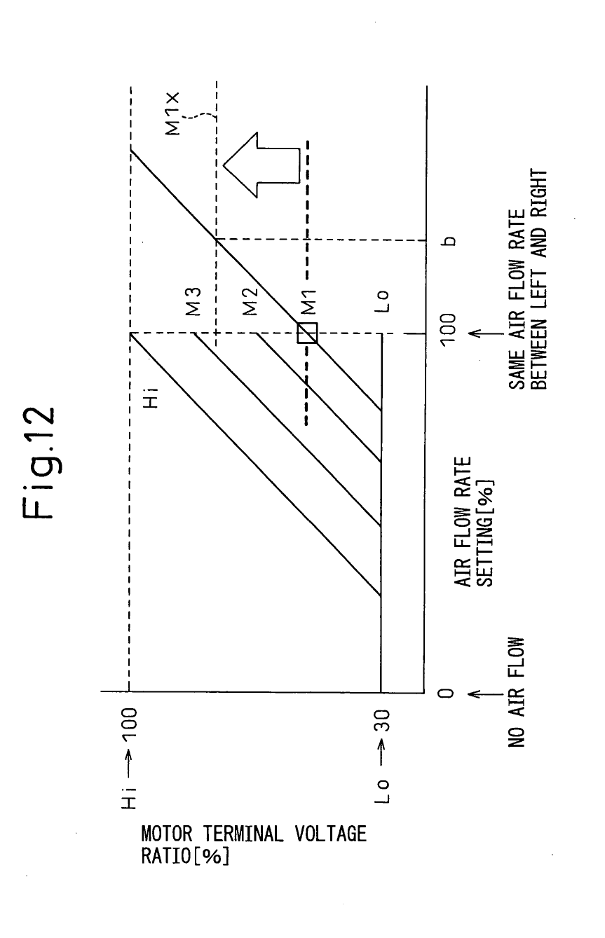

In this case, in order to prevent the air flow rate in the right side air passage 18 from decreasing because of the increase in the air flow rate in the left side air passage 18, the motor terminal voltage of the fan 10 is corrected and raised as shown in FIG. 12. In other words, the example in FIG. 12 shows a case where the motor terminal voltage is at the M1 level when the air flow rate setting in the left side air passage 18=100%. When the air flow rate in only the left side air passage 18 is increased to b %, the flow rate of which is higher than 100%, as described above, the motor terminal voltage of the fan 10 is raised from the M1 level to the Mlx level. Mix is expressed by the following equation 2.

M1x=M1x{0.5+0.5×(b/100)} (Equation 2)

When the motor terminal voltage of the fan 10 is raised from the M1 level to the Mix level, the total air flow rate in the left side and right side passages 18 and 19 can be increased by the flow rate increase corresponding to the air flow rate increase in the left side air passage 18 and a change in the air flow rate in the right side air passage 19 can be avoided.

As described above, in the second embodiment, by correcting the motor terminal voltage of the fan 10 in an interlocked relation with the change in the door opening degree of one of the left side and right side passages 18 and 19, the air flow rate of which is changed, so as to correct the total air flow rate of the left side and right side passages 18 and 19 (that is, the air flow rate of the fan 10), it is possible to prevent, without fail, a change in the air flow rate of the other passage, the air flow rate of which is not changed.

(Third Embodiment)

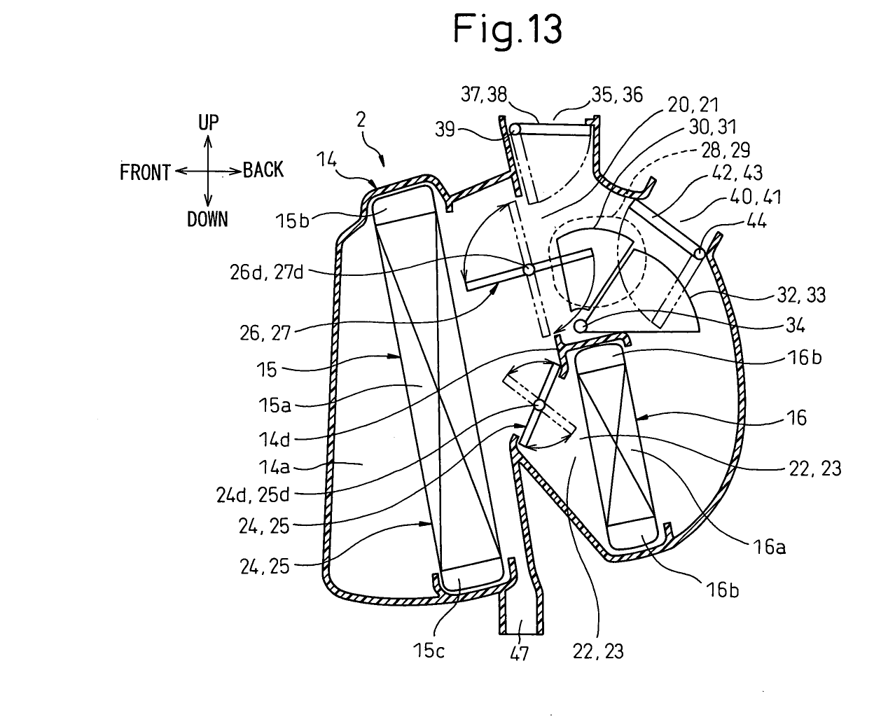

In the first embodiment, the hot air mix doors 24 and 25 and the cold air mix doors 26 and 27 in the left side and right side passages 18 and 19 are made of the film doors using the thin film members 24a, 25a, 26a and 27a, but in the third embodiment, the hot air mix doors 24 and 25 and the cold air mix doors 26 and 27 in the left side and right side passages 18 and 19 are each made of board doors rotatable about axes of rotation 24d, 25d, 26d and 27d as shown in FIG. 13.

According to the third embodiment, it is possible to control the discharged air temperature and the air flow rate, in the left side passage 18 and the right side passage 19, by controlling the angles of rotation of the hot air mix doors 24 and 25 and cold air mix doors 26 and 27 to adjust the opening areas of the hot air passages 22 and 23 and the opening areas of the cold air passages 20 and 21. Therefore, the same function and effect as those in the first embodiment can be attained also in the third embodiment.

(Other Embodiments)

In the first embodiment, one end of each of the thin film members 24a, 25a, 26a and 27a making the hot air mix doors 24 and 25 and the cold air mix doors 26 and 27 in the left side and right side passages 18 and 19 is fixed on the case 14 and the other end of each of the thin film members 24a, 25a, 26a and 27a is wound by each of the winding shafts 24c, 25c, 26c and 27c, or paid out from each of the winding shafts 24c, 25c, 26c and 27c, and thus the opening areas of the hot air passages 22 and 23 and the cold air passages 20 and 21 are changed, but the configuration of the air mix doors using the thin film members can be changed to such one as disclosed in Japanese Unexamined Patent Publication (Kokai) No. 2002-79819.

In Japanese Unexamined Patent Publication (Kokai) No. 2002-79819, a slide type door, in which a film-like member having flexibility is slid and shifted on a sealing surface on a case, is disclosed and a slide door of such a type may be used to make the hot air mix doors 24 and 25 and the cold air mix doors 26 and 27.

Moreover, a configuration is possible in which instead of a film-like member having flexibility, a slide door made of a rigid body is used to make each of the hot air mix doors 24 and 25 and the cold air mix doors 26 and 27, and the opening areas of the hot air passages 22 and 23 and the cold air passages 20 and 21 may be changed independently by sliding the rigid body slide doors on the sealing surfaces of the case. Any door means may be used as long as the opening areas of the hot air passages 22 and 23 and the cold air passages 20 and 21 can be changed independently.

In the first embodiment described above, the case is explained where the left side and right side foot doors 32 and 33, the left side and right side defroster doors 37 and 38 and the left side and right side face doors 42 and 43 in the vehicle left side passage 18 and right side passage 19 are all switched, in an interlocked relationship between the left side and right side blowing modes, by the single blowing mode operation mechanism, but the left side and right side foot doors 32 and 33, the left side and right side defroster doors 37 and 38 and the left side and right side face doors 42 and 43 may be operated independently of each other on the vehicle left side air passage 18 and in the vehicle right side air passage 19 so that the left side and right side blowing modes may be switched independently.

To be specific, the left side blowing mode doors 32, 37 and 42 arranged within the vehicle left side air passage 18 are connected to the left side blowing mode operation mechanism and the right side blowing mode doors 33, 38 and 43 arranged within the vehicle right side air passage 19 are connected to the right side blowing mode operation mechanism. The left side blowing mode operation mechanism and the right side blowing mode operation mechanism are each provided with a servomotor and a link mechanism for transmitting the rotation of the servomotor to each door described above, and by controlling the number of rotations of each of the left side and right side servomotors, each of the left side and right side doors is opened and closed via the link mechanism and thus the left side and right side blowing modes can be switched independently.

Moreover, in the first to third embodiments described above, a case is described where the temperature and the flow rate of air discharged to the left side zone in a vehicle compartment are controlled independently of the temperature and the flow rate of air discharged to the right side zone thereof but the present invention may be applied to a case where the temperature and the flow rate of air discharged to the front zone in a vehicle compartment are controlled independently of the temperature and the flow rate of air discharged to the back zone thereof.

While the invention has been described by reference to specific embodiments chosen for the purposes of illustration, it should be apparent that numerous modifications could be made thereto by those skilled in the art without departing from the basic concept and scope of the invention.

1. An air conditioner for a vehicle: wherein
a first cold air passage through which cold air flows and a first hot air passage through which hot air flows are provided, in parallel with each other, in a first air passage through which conditioned air is discharged to a first zone in a vehicle compartment;
a second cold air passage through which cold air flows and a second hot air passage through which hot air flows are provided, in parallel with, each other in a second air passage through which conditioned air is discharged to a second zone in a vehicle compartment;
the first air passage comprises a first cold air door for opening and closing the first cold air passage and a first hot air door for opening and closing the first hot air passage;
the second air passage comprises a second cold air door for opening and closing the second cold air passage and a second hot air door for opening and closing the second hot air passage;
the temperature of air discharged from the first air passage into the first zone is adjusted by adjusting the proportion of the flow rate of cold air in the first cold air passage with respect to the flow rate of hot air in the first hot air passage by means of the first cold air door and the first hot air door;
the temperature of the air discharged from the second air passage into the second zone is adjusted by adjusting the proportion of the flow rate of cold air in the second cold air passage with respect to the flow rate of hot air in the second hot air passage by means of the second cold air door and the second hot air door;
the air flow rate in the first air passage is controlled independently by changing the passage opening area of the first air passage by means of the first cold air door and the first hot air door while the proportion of the flow rate of cold air with respect to the flow rate of hot air adjusted by means of the first cold air door and the first hot air door is maintained to be constant; and
the air flow rate in the second air passage is controlled independently by changing the passage opening area of the second air passage by means of the second cold air door and the second hot air door while the proportion of the flow rate of cold air with respect to the flow rate of hot air adjusted by means of the second cold air door and the second hot air door is maintained to be constant.

2. An air conditioner for a vehicle, as set forth in claim 1, comprising:
a first temperature setting means operated by a passenger and for generating a temperature setting signal of the first zone;
a second temperature setting means operated by a passenger and for generating a temperature setting signal of the second zone;
a first air flow rate adjusting means operated by a passenger and for generating a discharged air flow rate adjusting signal of the first air passage;
a second air flow rate adjusting means operated by a passenger and for generating a discharged air flow rate adjusting signal of the second air passage;
a first door operation mechanism for operating the first cold air door and the first hot air door;
a second door operation mechanism for operating the second cold air door and the second hot air door; and
a control means for receiving signals from the first temperature setting means, the second temperature setting means, the first air flow rate adjusting means and the second air flow rate adjusting means to control the first door operation mechanism and the second door operation mechanism, wherein
the first door operation mechanism is controlled by the control means when a discharged air flow rate adjusting signal of the first air passage is generated by the first air flow rate adjusting means, so that the first cold air door and the first hot air door are operated to be shifted to positions which provide passage opening areas in accordance with the increase or decrease in air flow rate specified by the discharged air flow rate adjusting signal; and wherein
the second door operation mechanism is controlled by the control means when a discharged air flow rate adjusting signal of the second air passage is generated by the second air flow rate adjusting means, so that the second cold air door and the second hot air door are operated to be shifted to positions which provide passage opening areas in accordance with the increase or decrease in air flow rate specified by the discharged air flow rate adjusting signal.

3. An air conditioner for a vehicle, as set forth in claim 2, comprising a single fan for supplying air to the first air passage and the second air passage; wherein
the control means calculates a target blowing air temperature (TAOL) of air discharged from the first air passage into the first zone and a target blowing air temperature (TAOR) of air discharged from the second air passage into the second zone; wherein
the control means determines a reference air flow rate of the air flow rate from the first air passage and the second air passage by controlling the air flow rate of the fan based on at least one of the target blowing air temperatures (TAOL, TAOR); wherein
the control means controls the first door operation mechanism so as to increase or decrease the reference air flow rate when a discharged air flow rate adjusting signal of the first air passage is generated by the first air flow rate adjusting means; and wherein
the control means controls the second door operation mechanism so as to increase or decrease the reference air flow rate when a discharged air flow rate adjusting signal of the second air passage is generated by the second air flow rate adjusting means.

4. An air conditioner for a vehicle, as set forth in claim 1, comprising a single fan for supplying air to the first air passage and the second air passage, wherein
when air flow rate in one of the first air passage and the second air passage is changed by means of the cold air door and the hot air door provided in the passage, air flow rate of the fan is corrected so that change in air flow rate in the other passage can be kept small.

5. An air conditioner for a vehicle, as set forth in claim 1, wherein each of the first cold air door, the first hot air door, the second cold air door and the second hot air door is made of a film door which comprises a film-like member and changes the passage opening area by moving each of the film-like members.

6. An air conditioner for a vehicle, as set forth in claim 1, wherein each of the first cold air door, the first hot air door, the second cold air door and the second hot air door is made of a board door rotatable about each axis of rotation.

7. An air conditioner for a vehicle, comprising:
a first air passage through which conditioned air is discharged to a first zone in a vehicle compartment;
a second air passage through which conditioned air is discharged to a second zone in a vehicle compartment;
a single fan for supplying air to the first air passage and the second air passage;
a first door means for independently controlling the air flow rate in the first air passage by changing the passage opening area of the first air passage; and
a second door means for independently controlling the air flow rate in the second air passage by changing the passage opening area of the second air passage.

8. An air conditioner for a vehicle, as set forth in claim 1, wherein
the first zone is a left side zone in a vehicle compartment and the first air passage is a vehicle left side air passage, wherein
the second zone is a right side zone in a vehicle compartment and the second air passage is a vehicle right side air passage, wherein
the air temperature and the flow rate of air discharged from the vehicle left side air passage are independently controlled by means of the first cold air door and the first hot air door, and wherein
the air temperature and the flow rate of air discharged from the vehicle right side air passage are independently controlled by means of the second cold air door and the second hot air door.

9. An air conditioner for a vehicle, as set forth in claim 7, wherein
the first zone is a left side zone in a vehicle compartment and the first air passage is a vehicle left side air passage, wherein
the second zone is a right side zone in a vehicle compartment and the second air passage is a vehicle right side air passage, wherein
the air temperature and the flow rate of air discharged from the vehicle left side air passage are independently controlled by means of the first cold air door and the first hot air door, and wherein
the air temperature and the flow rate of air discharged from the vehicle right side air passage are independently controlled by means of the second cold air door and the second hot air door.

10. An air conditioner for a vehicle, as set forth in claim 1, comprising:
operation mechanisms each capable of controlling the first cold air door, the first hot air door, the second cold air door and the second hot air door independently of each other;
a first temperature setting means for generating a temperature setting signal of the first air passage;
a second temperature setting means for generating a temperature setting signal of the second air passage;
a first air flow rate setting means for generating an air flow rate setting signal of the first air passage;
a second air flow rate setting means for generating an air flow rate setting signal of the second air passage; and
a control means for receiving signals from the first temperature setting means, the second temperature setting means, the first air flow rate setting means and the second air flow rate setting means and for controlling each of the operation mechanisms for each of the doors independently of each other.
